(19) United States
(12) Patent Application Publication
(10) Pub. No.: US 2012/0157613 A1
(43) Pub. Date: Jun. 21, 2012

(54) BULK POLYMERIZATION OF (METH)ACRYLATE COPOLYMERS SOLUBLE UNDER AQUEOUS-ALKALINE CONDITIONS

(75) Inventors: Dirk Poppe, Frankfurt am Main (DE); Wolfgang Janas, Geiselbach (DE); Frank Kleinsteinberg, Alpen (DE); Anja Christofzik, Bochum (DE)

(73) Assignee: EVONIK ROEHM GmbH, Darmstadt (DE)

(21) Appl. No.: 13/393,390

(22) PCT Filed: Oct. 7, 2010
(86) PCT No.: PCT/EP2010/064957

§ 371 Date: Feb. 29, 2012

(30) Foreign Application Priority Data
Nov. 20, 2009 (DE) 10 2009 046 922.2

(51) Int. Cl. C09D 133/10; C08L 33/10; C08F 4/04; C08F 20/10

(52) U.S. Cl. 524/561; 526/318.44; 526/218.1

(57) ABSTRACT

The invention relates to the synthesis of (meth)acrylate-based mass polymers which are soluble in aqueous alkaline. The invention in particular relates to the synthesis of polymers by means of a mass polymerization. Said mass polymers have a significantly improved solubility in aqueous alkaline media over corresponding polymers produced by means of a heterogeneous aqueous polymerization method, such as emulsion or suspension polymerization. Improved solubility in said context refers to the dissolution rate being faster among particles of equal size, to no significant turbidity remaining after dissolution and to the viscosity of the obtained solutions being lower at the identical ratio of solids content. Furthermore, the compatibility of the compounds according to the invention with water-based varnishes is at least comparable or even improved.

### FIELD OF THE INVENTION

The present invention relates to the synthesis of (meth)acrylate-based bulk polymers soluble under aqueous-alkaline conditions. More particularly the present invention relates to the synthesis of polymers by means of a bulk polymerization. Bulk polymers of this kind have significantly better solubility in aqueous-alkaline media than do corresponding polymers prepared by means of a heterogeneous aqueous polymerization method, such as emulsion or suspension polymerization. Better solubility in this context means that the dissolution rate for particles of equal size is quicker, that there is no significant clouding left after dissolution, and that the viscosity of the resultant solutions, for identical solids content, is lower. Furthermore, the compatibility of the compounds of the invention for water-based coating materials is at least comparable or even improved.

### PRIOR ART

EP 1 268 690 describes acrylate-based binders for aqueous coating materials, while WO 2005/058993 describes binders for the combination of acrylates and polyurethanes. The vinyl component in these cases is prepared by emulsion polymerization. An advantage of emulsion polymerization over methods such as solution polymerization or as bulk polymerization is that aqueous dispersing can take place directly in the polymerization medium. If, however, processing takes place not directly in an aqueous solution or dispersion, but instead in an extruder, for compounding, for example, water is found to be a particularly disadvantageous medium, on account of the high polarity and boiling point. A further disadvantage of emulsion polymerization for coatings applications is the large amount of auxiliaries and process media, which are costly and inconvenient to remove from the binder and which affect the quality of the coating material.

Suspension polymers, in contrast, can be prepared with fewer auxiliaries and process media. Conversely, polymers with high acid numbers, and hence good dispersibility in water, are difficult to realize. A large number of acid groups disrupts droplet formation at the interface of the monomers with the aqueous phase, or a large proportion of the acid-containing monomers are simply dissolved in the aqueous phase and hence are no longer available to the polymerization. One example of a commercially available suspension polymer of this kind is the acrylate binder available under the name Neocryl B 817 from DSM B.V. (Geleen, NL).

These boundary phase effects, which occur both with emulsion polymerization and with suspension polymerization, have the further effect of a non-uniform distribution of the acid groups across the polymer chains. Accordingly, the chains contain apolar and polar segments. This chain construction, however, in an aqueous solution results in two additional disadvantages: first, aqueous solutions and coating materials comprising such aqueous dispersions tend towards clouding as a result of phase separations; second, aqueous solutions and dispersions of such segmented polymers exhibit significantly higher solution viscosities than similar polymers of regular structure.

As well as optical clarity and good solubility or dispersibility in water, acrylate binders for modern aqueous coating systems are required to have further properties, which to date have not been adequately met by the state of the art. Ideally, the binders would have high compatibility with a large number of different coating systems. Examples include polyurethanes, other poly(meth)acrylates, polyesters or epoxy systems. At the same time, however, the binders ought also to have good pigment dispersing properties. Only well-dispersed pigments will result, in a subsequent coating material, in high depth of colour and uniformity and hence in a desired coating quality. Furthermore, in combination with other film-forming binders, the poly(meth)acrylates ought to make a positive contribution to these properties. Prior-art poly(meth)acrylates, however, do not have the combination of these desired properties.

Continuous bulk polymerization for the preparation of acid-functional poly(meth)acrylates has in principle been described before.

EP 0 143 935 describes copolymers of ethyl acrylate and methacrylic acid which contain at least 17% by weight of methacrylic acid and are used for producing protective films which can be broken down by treatment with alkaline solutions. The polymers are prepared using a twin-screw extruder. For coatings applications, however, these polymers, composed of two different units, are not suitable. The polymers are incompatible with other systems and, because of the high acid number, tend towards clouding.

WO 01/05841 uses continuous polymerization to prepare epoxy-functional poly(meth)acrylates for powder coating applications. They are unsuitable for aqueous systems, however. Also illustrated is the synthesis of very short-chain polyacrylates containing 35% by weight of acrylic acid. These polymers, however, are suitable neither for dispersing pigments nor for compounding with other polymers.

WO 02/18456 discloses a process in which two reaction zones, generally tube reactors, are used continuously for the synthesis of acid-containing polymethacrylates, the monomer composition added in the second reactor zone differing primarily in terms of the functional groups from the first composition. Accordingly, mixtures of different polymer compositions are always obtained, for systems which have in-chain acrylic groups and are cured by an electron beam. The process, generally speaking, can be operated only with addition of solvents or for very low molecular weights M_{w} of much less than 10 T. Moreover, the polymers prepared for aqueous dispersing have an acrylic acid and/or maleic acid fraction of at least 30% by weight. Such systems display the disadvantages already highlighted, and are not suitable for pigment dispersion in aqueous systems.

WO 00/02933 employs the same technical process to combine, in a two-stage operation, a free-radical polymerization with a polycondensation. The products obtainable via this costly and inconvenient process represent a mixture of very different polymer species, whose complete aqueous dispersibility or solubility is poor. Moreover, heterogeneous polymer architectures of this kind are probably not sufficiently suitable for the complete dispersing of pigments.

In WO 00/02934, in turn, continuous bulk polymerization, with addition of 10% to 15% by weight of a solvent, is used to prepare acid-containing polyacrylates for producing pigment preparations for aqueous systems, particularly for printing inks. A feature of these polyacrylates is that they contain at least 8.5% by weight of acrylic esters of alcohols having at least 11 carbon atoms. In order to produce dispersibility in aqueous systems with this large fraction of apolar units, the polymers must, correspondingly, contain at least 18% by weight of acrylic acid. This composition, however, is suitable only for a small number of pigments of the kind employed, for example, in printing inks, but not in coating materials.

### Problem

A problem addressed by the present invention was that of providing improved binders based on acrylate and/or methacrylate (hereinafter, for short, (meth)acrylate) for aqueous coating formulations.

More particularly a problem addressed was that of providing a (meth)acrylate binder for aqueous coating systems that allows production of pigment preparations which can be incorporated easily and with effective pigment distribution into established coating systems.

A further problem addressed was the possibility of processing these pigment preparations further into aqueous coating materials which have very good gloss, hiding, processing and colour properties.

A problem addressed at the same time by the present invention was to prepare said binder by means of a continuous preparation process. What is meant by this continuous preparation process is a process which can be carried out continuously, without interruption, consisting individually of the process steps of monomer metering, polymerization, degassing, and pelletizing.

### Solution

The problems have been solved through provision of an innovative bulk polymer. This polymer is prepared by the modified use of a continuous bulk polymerization process which can be used to polymerize functional (meth)acrylates solventlessly and with high conversion. The advantage of a bulk polymerization process over suspension polymerization is the high purity of the products, which can be prepared without addition of auxiliaries such as emulsifiers, stabilizers, defoamers or other suspension auxiliaries.

In order to be able to produce a pigment preparation in accordance with the current and future requirements of the coatings industry in respect of VOC content (fraction of volatile organic constituents) using the binder of the invention, the binder must have an extremely low fraction of volatile components. This has been achieved, in accordance with the invention, by providing the binder in solvent-free and water-free form by means of a continuous bulk polymerization. By combination with a thermal after treatment, moreover, a feature of the present invention is also that the residual monomer content is very low and the thermal stability of the binders is improved.

It has been found, surprisingly, that the process of the invention can also be used to prepare (meth)acrylate-based binders which contain both acid groups and hydroxyl groups. For producing such critical binders, the skilled person would prefer to use polymerization methods where these two species of monomer were either highly diluted (solution polymerization) or separated on the basis of different polarities (suspension polymerization).

Furthermore, surprisingly, compositions have been found which not only are soluble or dispersible under aqueous-alkaline conditions but are also very suitable for producing pigment preparations. In addition, coating materials comprising these pigment preparations exhibit very good gloss, hiding, processing and colour properties. Moreover, the pigment preparations can be produced and processed, using the binders of the invention, more easily than in the prior art. More particularly, this technical problem has been solved by successful provision of binders whose acid fraction is low by comparison with the prior art, without an accompanying adverse effect on the solubility or dispersibility under aqueous-alkaline conditions.

A particular feature of the present invention is the provision of a combination of structural units which fulfils precisely these requirements on the binder. To this end, only combinations of the following structural units are suitable:

Methacrylates which are polymerized are selected from the group of alkyl methacrylates of straight-chain, branched or cycloaliphatic alcohols having 1 to 8 carbon atoms. Mixtures of these can also be employed. Preferred examples are methyl methacrylate, ethyl methacrylate, propyl methacrylate, n-butyl methacrylate, isobutyl methacrylate, tert-butyl methacrylate, pentyl methacrylate, 2-ethylhexyl methacrylate or cyclohexyl methacrylate. Particularly preferred is methyl methacrylate (MMA).

Acrylates which are polymerized are selected from the group of alkyl acrylates of straight-chain, branched or cycloaliphatic alcohols having 1 to 8 carbon atoms. Mixtures of these can also be employed. Preferred examples are methyl acrylate, ethyl acrylate, propyl acrylate, n-butyl acrylate, isobutyl acrylate, tert-butyl acrylate, pentyl acrylate, 2-ethylhexyl acrylate or cyclohexyl acrylate. Particularly preferred is ethyl acrylate (EA).

Besides the above-described (meth)acrylates, the compositions for polymerization may also contain further unsaturated monomers which are copolymerizable with the aforementioned (meth)acrylates. These include, in particular, styrene, α-methylstyrene or p-methylstyrene, preferably styrene.

Additionally present in the compositions for polymerization are (meth)acrylates or mixtures of (meth)acrylates which contain a hydroxyl functionality. Preferred examples are hydroxyethyl acrylate, hydroxyethyl methacrylate, hydroxypropyl acrylate and hydroxypropyl methacrylate.

Lastly, the mixtures for polymerization include acrylic acid and/or methacrylic acid.

A further particular feature of the present invention is the provision of the proportions between the individual structural units that are suitable for solving the technical problems. In this context it has been found, particularly surprisingly, that the polymers of the invention can be prepared for producing pigment preparations which are soluble or dispersible under aqueous-alkaline conditions and whose acid fraction is low by comparison with the prior art.

The binder of the invention for producing pigment preparations is notable in particular for the fact that it is soluble or dispersible in aqueous-alkaline solutions and has good dispersing properties for a host of different kinds of pigments. This property is achieved more particularly by the binder being prepared exclusively from the following monomers:
40% to 70%, preferably 45% to 65%, by weight of one or more methacrylates which contain an alkyl radical of 1 to 8 carbon atoms, and/or styrene and/or α-methylstyrene.
   Preferably this monomer is methyl methacrylate, styrene or a mixture of methyl methacrylate and styrene.
20% to 40%, preferably 25% to 35%, by weight of one or more acrylates which contain an alkyl radical of 1 to 8 carbon atoms. Preferably this acrylate is ethyl acrylate.
1% to 15%, preferably 4% to 10%, by weight of one or more (meth)acrylates which contain a hydroxyl function on the alkyl radical. Preferably this monomer is hydroxypropyl(meth)acrylate or hydroxyethyl(meth)acrylate.
1% to 17%, preferably 7% to 15%, by weight of acrylic acid and/or methacrylic acid. Preferably this monomer is acrylic acid.

In a first, relatively soft composition, suitable more particularly for producing vehicle finishes, the following composition is preferred:
40% to 60%, preferably 45% to 60%, by weight of one or more methacrylates which contain an alkyl radical of 1 to 8 carbon atoms. Preferably this methacrylate is methyl methacrylate.
20% to 40%, preferably 25% to 35%, by weight of one or more acrylates which contain an alkyl radical of 1 to 8 carbon atoms. Preferably this acrylate is ethyl acrylate.
0% to 10%, preferably up to 5%, by weight of styrene and/or α-methylstyrene. Preferably this monomer is exclusively styrene.
1% to 15%, preferably 4% to 10%, by weight of one or more (meth)acrylates which contain a hydroxyl function on the alkyl radical. Preferably this monomer is hydroxypropyl(meth)acrylate or hydroxyethyl(meth)acrylate.
1% to 17%, preferably 7% to 15%, by weight of acrylic acid and/or methacrylic acid. Preferably this monomer is acrylic acid.

In an alternative, relatively hard composition, suitable more particularly for architectural paints, known as decorative paints, the following composition is preferred:
0% to 10% by weight of one or more methacrylates which contain an alkyl radical of 1 to 8 carbon atoms. Preferably this methacrylate is methyl methacrylate.
20% to 40% by weight of one or more acrylates which contain an alkyl radical of 1 to 8 carbon atoms. Preferably this acrylate is ethyl acrylate.
40% to 60% by weight of styrene.
1% to 15%, preferably 4% to 10%, by weight of one or more (meth)acrylates which contain a hydroxyl function on the alkyl radical. Preferably this monomer is hydroxypropyl(meth)acrylate or hydroxyethyl(meth)acrylate.
1% to 17%, preferably 7% to 15%, by weight of acrylic acid and/or methacrylic acid. Preferably this monomer is acrylic acid.

Independently of the composition, the binders have a mass-average molecular weight M_{w} of at least 5 T, preferably at least 10 T and at most of 80 T, preferably of 50 T. The molecular weight is measured in a method based on DIN 55672-1, “Gel permeation chromatography, part 1: tetrahydrofuran (THF) as eluent” by means of gel permeation chromatography (GPC) against a PMMA standard.

The binders of the invention are prepared by means of a process which is innovative for the preparation of such systems. A feature of this process is that the monomer mixtures listed are innovative in respect of a continuous bulk polymerization in a kneading device. Furthermore, the polymerization process is carried out free from solvents and auxiliaries. In addition, the polymer is pelletized directly subsequent to the polymerization.

One advantage of bulk polymerization over suspension polymerization is the use of any desired amounts of hydrophilic comonomers such as (meth)acrylic acids, amino-functional or hydroxy-functional (meth)acrylates.

The advantage over solution polymerization is the absence of or only very small fraction of volatile constituents in the polymerization procedure and in the primary product. The advantage of the process of the invention over a bulk polymerization in batch mode is the significantly higher conversion which can be achieved, and hence the lower fraction of residual monomers in the end product. Further factors are a higher production rate and a broader possibility for variation of the operational parameters.

A particular advantage of the process of the invention for preparing binders for coating materials or paints is the form in which the product is obtained at the end of the production operation, without further processing. Through the combination of a continuously operated kneading device for the polymerization, a degassing stage such as, for example, a flash degasser or a degassing kneading device for the removal of volatile constituents and for the thermal aftertreatment of the polymer, and a pelletizer, products are obtained which firstly are free from solvents and secondly are composed exclusively of constituents which originate from the employed monomers, chain-transfer reagents and initiators and which have an adjustable pellet size.

The binder prepared in accordance with the invention further comprises no coarse constituents, i.e. particles greater than 5 mm. Larger particles can lead to instances of clogging, of nozzles and dies, for example. A particular disadvantage of such coarse material is, more particularly, the reduced solubility rate in organic solvents, plasticizers or water. This is an easy-to-appreciate consequence of the less favourable surface area/mass relationship as compared with smaller particles.

The preferred process for solving the problem is the technology of a continuously operated kneading device. A description of a backmixed kneading reactor of this kind for continuous bulk polymerization, from the company List, is found in WO 2006/034875 or in WO 2007/112901. The polymerization is conducted at above the glass transition temperature of the polymer. Monomers, catalysts, initiators etc. are passed continuously into the reactor and backmixed with product that has already undergone reaction. At the same time, product which has undergone reaction is removed continuously from the mixing kneading device. The unreactive monomer is separated off by a residue degasser, and can be supplied to the reactor again. In this residue degasser, at the same time, the polymer undergoes thermal aftertreatment.

The product can be thermally aftertreated when polymerization has been concluded. At a temperature above 90° C., preferably above 110° C., volatile constituents present in the product, such as residual monomers or optionally used solvent, can be removed. The monomers recovered in this way may optionally be recycled to the polymerization procedure. A procedure of this kind is easy to implement in the kneading-device technology, by means of an attached process step such as flash degassing, a degassing kneading device or a degassing extruder.

Polymerization initiators used, which are generally added to the monomer phase, are the free-radical initiators that are typically used, more particularly peroxides and azo compounds. In certain circumstances it may be advantageous to use a mixture of different initiators. The amount for use is situated generally in the range between 0.1 and 5 percent by weight, based on the monomer phase. Used preferably as free-radical initiators are azo compounds such as azobisisobutyronitrile, azobis(2,4-dimethyl)-valeronitrile, 1,1′-azobis(cyclohexanecarbonitrile) (WAKO® V40), 2-(carbamoylazo)isobutyronitrile (WAKO® V30) or peroxides such as tert-butyl peroctoate, tert-butyl perbenzoate, octanoyl peroxide, decanoyl peroxide, lauroyl peroxide, benzoyl peroxide, monochlorobenzoyl peroxide, dichlorobenzoyl peroxide, p-ethylbenzoyl peroxide, di(tert-butyl) peroxide (DTBP), di(tert-amyl) peroxide (DTAP), tert-butyl peroxy(2-ethylhexyl) carbonate (TBPEHC), and other peroxides which decompose at a high temperature. By free-radical initiators which decompose at a high temperature are meant compounds having a half-life of an hour in a temperature range from 85 to 150° C. To set the molecular weight of the polymer formed it is also possible, conventionally, to add up to 8% by weight of one or more conventional chain regulators to the monomer phase. Examples that may be mentioned include the following: mercaptans, such as n-butyl mercaptan, n-octyl mercaptan, n-dodecyl mercaptan, tert-dodecyl mercaptan or mercaptoethanol; thioglycolic acid or thioglycolic esters such as isooctyl thioglycolate or lauryl thioglycolate; aliphatic chlorine compounds; enol ethers or dimeric α-methylstyrene.

If branched polymers are to be prepared, the monomer phase may also contain up to about one percent by weight of polyfunctional monomers, examples being ethylene glycol di(meth)acrylate, butane diol di(meth)acrylate or divinylbenzene.

The bulk polymer of the invention, preferably in the form of pellets, is compounded preferably with pigments, and optionally further additives, to give a pigment preparation. Compounding is preferably accomplished by means of extrusion. The product produced accordingly is in the form of pellets which comprise a high fraction of pigments and which can be incorporated into a coating composition with binders and further coating constituents. For this purpose, the pellets, together with these other constituents, are dissolved in an alkaline-aqueous medium. This solution can be used as an aqueous coating material. The pellets may contain between 20% and 80% by weight of pigments. These pigments, without imposing any restriction, may be, for example, carbon black, organic pigments or mineral pigments.

Although these pigment preparations have been developed primarily for use in aqueous coating formulations, the pellets can also be used in solvent-based coating systems, high-solids systems or 100% systems.

The field of application for the coating formulations prepared in this way is broad. They are preferably used in coatings on surfaces, for example, of metal, plastic, ceramic or wood. Examples are, in particular, the use of the pigment preparations in architectural paints, marine paints or container paints, and more particularly in automotive finishes.

The examples given below are given for better illustration of the present invention, but have no capacity to confine the invention to the features disclosed therein.

### EXAMPLES

### Particle Sizes

The particle sizes and the particle-size distributions, reported below in the form of the d₅₀ value, were determined using a Coulter LS 13 320 in accordance with ISO 13320-1 in a measurement range between 0.04 μm and 2000 μm. The average particle size d₅₀ identifies the median of the particle diameter, based on the particle volume; in other words, 50% of the total particle volume is smaller, and 50% larger, than the average particle size. Particle sizes larger than 2000 μm were determined additionally using a Camsizer from Retsch Technology in accordance with ISO/FDISm13322-2.2:2006(E).

Measurement of Glass Transition Temperatures

The glass transition temperatures T_{g} are measured by means of dynamic scanning calorimetry (DSC) in accordance with ISO 11357-2.

Measurement of Dissolution Times

The dissolution times of the unmodified products from the example syntheses and comparative-example syntheses were measured on a 25% strength by weight aqueous solution. The stirring assembly used for this purpose was a magnetic stirring rod with a length of 4 cm and a magnetic stirrer (heating stirring plate) from IKA Labortechnik®, model RCT. In a 250 ml wide-neck glass vessel, 70.6 g of solvent (water), 2.2 g of ammonia solution (25% in water) and 2.2 g of DMEA solution (dimethylethylamine, 25% in water) were introduced. The polymer sample (25 g) was added with stirring (level 9). The lid is closed immediately. As soon as solids and suspended materials can no longer be observed on visual inspection, the magnetic stirrer is switched off, a record is made of the time, and the sample is subjected to optical evaluation.

Viscosity

The viscosity η of the binder solutions prepared in the context of the experiments for determining the dissolution time was measured by means of cone/plate geometry using a Haake RS1 from the company Thermo Elektron in accordance with DIN 53018. The rotating body used is the C35/2 Ti cone, with a diameter of 35.002 mm. The measurements were made as a function of the shear rate D.

Test Method for Determining the Coating Properties

The binder solution (6% pure resin) was incorporated into the respective coating system using a dissolver at 1500 rpm for 2 minutes. The time for incorporation of the curing agent in the case of the two-component (2K) PU systems was 2 minutes at 2000 rpm. The now fully-made-up coating material was applied to a glass plate using a 100 μm (NFD) four-way bar applicator. Following complete drying, the compatibility of the binder was assessed visually. The measure of compatibility is the transparency and the surface quality (smooth, cratering, etc.) of the film.

### Example B1

### Composition 1 (Continuous Bulk Polymerization)

A mixture consisting of 51.5% by weight of methyl methacrylate, 31% by weight of ethyl acrylate, 9% by weight of acrylic acid, 6.5% by weight of hydroxypropyl methacrylate, 2% by weight of cyclohexyl methacrylate, 0.9% by weight of a 50% strength by weight solution of tert-butyl peracetate in aliphatics (TRIGONOX F-050 from AKZO) and 2.8% by weight of isooctyl thioglycolate (TGIO) is supplied continuously to a backmixed kneading reactor from the company List, as described in WO 2006/034875, for example, and reacted polymer is withdrawn continuously from the reactor at the same time. The internal temperature within the reactor is 110° C., it being possible for the temperature to fluctuate by up to 10° C. The average residence time is approximately 40 minutes. The product was collected in a suitable vessel and then ground.

### Example B2

### Composition 2 (Continuous Bulk Polymerization)

A mixture consisting of 52.1% by weight of styrene, 30% by weight of ethyl acrylate, 13% by weight of acrylic acid, 4.9% by weight of hydroxyethyl methacrylate, 1.35% by weight of a 50% strength by weight solution of tert-butyl peracetate in aliphatics (TRIGONOX F-050 from AKZO) and 3.3% by weight of isooctyl thioglycolate (TGIO) is supplied continuously to a backmixed kneading reactor from the company List, as described in WO 2006/034875, for example, and reacted polymer is withdrawn continuously from the reactor at the same time. The internal temperature within the reactor is 130° C. The average residence time is approximately 20 minutes. The polymer melt is transferred immediately downstream of the reactor, via a melt pipe at 140° C., into a degassing kneading device from the company List, in which residual unreacted monomers are removed from the polymer at a temperature of 120° C. The product was collected in a suitable vessel and then ground.

### Example B3

### Composition 3 (Continuous Bulk Polymerization)

A mixture consisting of 54% by weight of methyl methacrylate, 31% by weight of ethyl acrylate, 9% by weight of acrylic acid, 6% by weight of hydroxypropyl methacrylate, 0.45% by weight of tert-butyl per-2-ethylhexanoate (TBPEH), 0.45% by weight of di-tert-amyl peroxide (DTAP) and 2.6% by weight of isooctyl thioglycolate (TGIO) is supplied continuously to a backmixed kneading reactor from the company List, as described in WO 2006/034875, for example, and reacted polymer is withdrawn continuously from the reactor at the same time. The internal temperature within the reactor is 120° C., it being possible for the temperature to fluctuate by up to 15° C. The average residence time is approximately 30 minutes. The polymer melt is transferred immediately downstream of the reactor, via a melt pipe at 130° C., into a degassing kneading device from the company List, in which residual unreacted monomers are removed from the polymer at a temperature of 130° C. Following degassing, the polymer melt is passed directly further to a Compact 120 underwater pelletizer from BKG GmbH, fitted with a 1.5 mm perforated plate. The pellets are subsequently dried in a Master 300 dryer, collected in a suitable vessel and subjected to determination of the particle size—as described above.

### Example B4

### Composition 4 (Continuous Bulk Polymerization)

A mixture consisting of 49.5% by weight of MMA, 26% by weight of ethyl acrylate, 18% by weight of acrylic acid, 6.5% by weight of hydroxypropyl methacrylate, 0.9% by weight of a 50% strength by weight solution of tert-butyl peracetate in aliphatics (TRIGONOX F-050 from AKZO) and 3.0% by weight of isooctyl thioglycolate (TGIO) is supplied continuously to a backmixed kneading reactor from the company List, as described in WO 2006/034875, for example, and reacted polymer is withdrawn continuously from the reactor at the same time. The internal temperature within the reactor is 110° C. The average residence time is approximately 20 minutes. The product was collected in a suitable vessel and then ground.

### Example B5

### Composition 5 (Continuous Bulk Polymerization)

A mixture consisting of 48% by weight of MMA, 30.5% by weight of ethyl acrylate, 13% by weight of acrylic acid, 2% by weight of styrene, 6.5% by weight of hydroxypropyl methacrylate, 0.9% by weight of a 50% strength by weight solution of tert-butyl peracetate in aliphatics (TRIGONOX F-050 from AKZO) and 2.8% by weight of isooctyl thioglycolate (TGIO) is supplied continuously to a backmixed kneading reactor from the company List, as described in WO 2006/034875, for example, and reacted polymer is withdrawn continuously from the reactor at the same time. The internal temperature within the reactor is 110° C. The average residence time is approximately 20 minutes. The polymer melt is transferred immediately downstream of the reactor, via a melt pipe at 130° C., into a degassing kneading device from the company List, in which residual unreacted monomers are removed from the polymer at a temperature of 120° C. The product was collected in a suitable vessel and then ground.

### Reference Example R1

### Composition 3 (Suspension Polymerization)

A 1 tonne reactor of VA stainless steel, equipped with Inter-MIG stirrer and reflux condenser, is charged with 460 kg of DI water, the stirrer is set to a speed of 70 revolutions per minute, and the reactor is heated to an external temperature of 40° C. 750 g of polyacrylic acid are added and dissolved by stirring. In a reservoir container, 265 kg (53% by weight) of methyl methacrylate, 155 kg (31% by weight) of ethyl acrylate, 50 kg (10% by weight) of acrylic acid, 30 kg (6% by weight) of hydroxypropyl methacrylate, 5 kg of tert-butyl perpivalate (25% strength by weight in aliphatics; TRIGONOX 25-C75) and 14 kg of isooctyl thioglycolate (TGIO) are mixed and homogenized with stirring. The monomer stock solution is drawn in under suction through a reduced internal reactor pressure of approximately 800 mbar, over a time of 15 minutes, and the reservoir container is rinsed out with 20 kg of DI water. The reactor is evacuated at a pressure of approximately 800 mbar over a time of 20 minutes and then is flooded with nitrogen. The internal temperature is regulated to 45° C. and raised successively to 65° C. over 4 hours. The polymerization is at an end when there is a halt in heat given off. The batch is cooled. The mother liquor is separated from the polymer beads using a suction filter (1 mm pore size), and drying takes places at 30° C. The particle size is determined as described above.

| | Example | Example | Example | Example | Example | Reference |
|---|---|---|---|---|---|---|
| | B1 | B2 | B3 | B4 | B5 | R1 |
| Molar mass M_{w}/g/mol | 21 100 | 17 900 | 21 500 | 22 100 | 25 200 | 19 500 |
| Residual monomer | 0.38 | 0.09 | 0.04 | 0.21 | 0.07 | 0.43 |
| content ethyl | | | | | | |
| acrylate/% | | | | | | |
| Residual monomer | 0.23 | — | 0.05 | 0.08 | 0.05 | <0.005 |
| content methyl | | | | | | |
| methacrylate/% | | | | | | |

| | Reference R1 | Example B3 | Example B1 |
|---|---|---|---|
| Molar mass M_{w}/g/mol | 19 500 | 21 500 | 21 100 |
| Particle size d₅₀/μm | 630 | 2300 | n.d. * |
| Glass transition temperature | 43 | 41 | 42 |
| T_{g}/° C. | | | |
| Dissolution time/min | 30 | 25 | 25 |
| Appearance of solution | cloudy | transparent | transparent |
| Viscosity η (D = 100 s⁻¹)/ | 7620 | 134 | 334 |
| mPas | | | |
| Viscosity η (D = 500 s⁻¹)/ | 1560 | 133 | 302 |
| mPas | | | |
| Viscosity η (D = 1000 s⁻¹)/ | 825 | 128 | 289 |
| mPas | | | |
| Compatibility | poor | good | moderate |

* n.d. = not determined

1. A binder obtained by a process comprising a continuous bulk polymerization of a combination of monomers consisting of:
from 40% to 70% by weight of the at least one methacrylate with an alkyl radical of from 1 to 8 carbon atoms, styrene, α-methylstyrene, or a combination thereof,
from 20% to 40% by weight of at least one acrylate with an alkyl radical of from 1 to 8 carbon atoms,
from 1% to 15% by weight of at least one (meth)acrylate with an alkyl radical having a hydroxyl function, and
from 1% to 17% by weight of acrylic acid, methacrylic acid, or a combination thereof,
wherein the binder is soluble in an aqueous alkaline solution.

2. The binder of claim 1,
wherein the combination of monomers consists of:
from 40% to 60% by weight of at least one methacrylate with an alkyl radical of from 1 to 8 carbon atoms,
from 0% to 10% by weight of styrene, α-methylstyrene, or a combination thereof,
from 20% to 40% by weight of the at least one acrylate,
from 1% to 15% by weight of the at least one (meth)acrylate with an alkyl radical having a hydroxyl function, and
from 1% to 17% by weight of acrylic acid, methacrylic acid, or a combination thereof.

3. The binder of claim 2, wherein the combination of monomers consists of:
from 45% to 60% by weight of the at least one methacrylate with an alkyl radical of from 1 to 8 carbon atoms,
from 0% to 5% by weight of styrene, α-methylstyrene, or a combination thereof,
from 25% to 35% by weight of the at least one acrylate,
from 4% to 10% by weight of the at least one meth(acrylate) with an alkyl radical having a hydroxyl function, and
from 7% to 15% by weight of acrylic acid, methacrylic acid, or a combination thereof.

4. The binder of claim 1,
wherein the combination of monomers consists of:
from 0% to 10% by weight of at least one methacrylate with an alkyl radical of from 1 to 8 carbon atoms,
from 40% to 60% by weight of styrene,
from 20% to 40% by weight of the at least one acrylate,
from 1% to 15% by weight of the at least one (meth)acrylate with an alkyl radical having a hydroxyl function, and
from 1% to 17% by weight of acrylic acid, methacrylic acid, or a combination thereof.

5. The binder of claim 1, wherein the combination of monomers consists of:
methyl methacrylate as the at least one methacrylate with an alkyl radical of from 1 to 8 carbon atoms,
styrene,
ethyl acrylate as the at least one acrylate with an alkyl radical of from 1 to 8 carbon atoms,
hydroxypropyl(meth)acrylate, hydroxyethyl(meth)acrylate, or a combination thereof, as the at least one (meth)acrylate with an alkyl radical having a hydroxyl function, and
acrylic acid.

6. The binder of claim 1, wherein a mass average molecular weight Mw of the binder is at least 10 T and at most of 50 T as measured by gel permeation chromatography.

7. A process for preparing the binder of claim 1, the process comprising:
polymerizing the combination of monomers continuously in a kneading apparatus to obtain a polymer, and
pelletizing the polymer directly subsequent to the polymerizing, to obtain a pellet of the binder
wherein the combination of monomers is free from solvents.

8. A process of producing a pigment preparation, comprising:
extruding the pigment preparation from a pellet of the binder of claim 1, a pigment, and an optional additive.

9. The process of claim 8, further comprising:
dissolving or dispersing the pigment preparation with a binder and a further coating constituent in an alkaline-aqueous medium, respectively to obtain a solution or dispersion.

10. An aqueous coating material, comprising a solution or dispersion obtained in a process comprising the process of claim 9.

11. The process of claim 7, further comprising:
thermally aftertreating the polymer at a temperature above 90° C.

12. The process of claim 11, wherein thermally aftertreating the polymer is at a temperature above 110° C.

13. The process of claim 7, wherein the polymerizing is in the presence of a polymerization initiator.

14. The process of claim 13, wherein the polymerization initiator is an azo compound.

15. The process of claim 7, wherein the pellet comprises between 20% and 80% by weight of a pigment.

16. The process of claim 8, wherein the pigment is carbon black, an organic pigment, a mineral pigment, or a combination thereof.

17. An architectural paint, marine paint, container paint, or automotive finish, comprising the binder of claim 1.
